(19) United States
(12) Patent Application Publication
(10) Pub. No.: US 2023/0320318 A1
(43) Pub. Date: Oct. 12, 2023

(54) BLANKET PET BED

(71) Applicant: WORLDWISE, INC., Novato, CA (US)

(72) Inventors: Aimee Diskin, Napa, CA (US); Hannah Rosenberg, San Francisco, CA (US)

(21) Appl. No.: 17/714,921

(22) Filed: Apr. 6, 2022

(51) Int. Cl. A01K 1/035

(52) U.S. Cl. CPC A01K 1/0353

(57) ABSTRACT

A pet bed having a cushion defined by a top surface area and a cushion peripheral edge. Sidewalls extending from the cushion peripheral edge within which the cushion receives and supports a pet during use. A blanket being sized larger than the top surface area having a blanket peripheral edge, whereby the entirety of the blanket peripheral edge is affixed proximate the cushion peripheral edge to reside atop the cushion.

### TECHNICAL FIELD

The present invention involves a pet bed such as the type having a cushion bounded by sidewalls. Unlike conventional beds, the present invention incorporates a blanket having a surface area considerably larger than the surface area presented by the cushion, the blanket being bound on the entirety of its peripheral edge proximate the cushion and generally where the cushion meets the bed's sidewalls. The blanket provides a nurturing surface distinctly unique as compared to the typical fabric which encloses cushions of this type.

### BACKGROUND OF THE INVENTION

The pet product arena includes pet beds of virtually every geometry and configuration. Such beds include those intended for cats and those intended for dogs and are sized accordingly. They all generally have a relatively soft cushion horizontally oriented when the bed resides upon a horizontal surface such as the pet owner's floor, patio or yard. Extending from the cushion area are stuffed sidewalls surrounding the centrally located cushion, the cushion area being defined by the sidewalls in most instances.

Pet bed cushions employ outer shell fabric containing a fill material ranging from down or synthetic foam to recycled fibers, the nature of the fill material defining the give associated with the cushion. The outer shell fabric defines the size of the cushion, the cushion either being freestanding (removable) or, in most instances, stitched at its periphery to a seam established by the bed's sidewalls. As the outer shell fabric is generally stuffed with cushioning material and is thus taut, the bed does not provide a particularly nurturing surface. For that reason, pets often times hop on to a pet owner's bed in order to nuzzle within blankets generally used as bedding by the pet owner. Pets find loose blankets having creases, bulges, indents and bunched fabric to be much more nurturing than the typical pet bed and its stuffed supportive cushion as cats use the loose blankets for kneading while dogs tend to burrow. None of this is possible with current pet beds.

There have been commercial attempts to improve upon existing pet beds, some of which include multi-ply membranes. Such membranes enable pets, generally cats seeking seclusion, beneath their top layer. Other than providing seclusion when desired, such products do little or nothing to satisfy the need of a pet to achieve a more nourishing environment. In addition, pets can become trapped between fabric layers and thus such products can become health hazards.

It is thus an object of the present invention to provide a pet bed which creates a more nourishing environment than such products currently available.

A further object of the present invention is to provide a secured but loose blanket atop a cushioning area of a pet bed to create a more nourishing environment, similar to one which may exist as part of the bedding of a typical pet owner.

These and further objects will be more readily apparent when considering the following disclosure and appended claims.

### SUMMARY OF THE INVENTION

A pet bed comprising a cushion having a top surface area and a cushion peripheral edge, sidewalls extending from said cushion within which said cushion receives and supports a pet during use,
a blanket, said blanket being sized larger than said top surface area having a blanket peripheral edge,
   whereby the entirety of said blanket peripheral edge is affixed proximate where said cushion contacts said sidewalls to reside atop said cushion.

### BRIEF DESCRIPTION OF THE FIGURES

FIG. 1 is a perspective view of the pet bed of the present invention.

FIG. 2 is a cross-sectional view of the pet bed of FIG. 1.

FIG. 3 is a top view of the pet bed of FIG. 1.

FIG. 4 is a top view of the blanket used and made part of the pet bed of FIG. 1

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

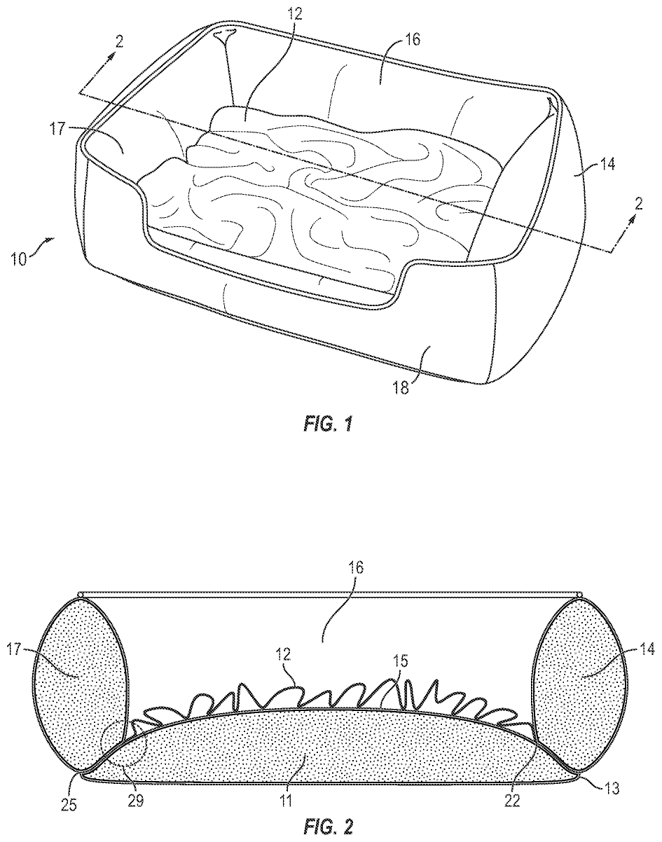

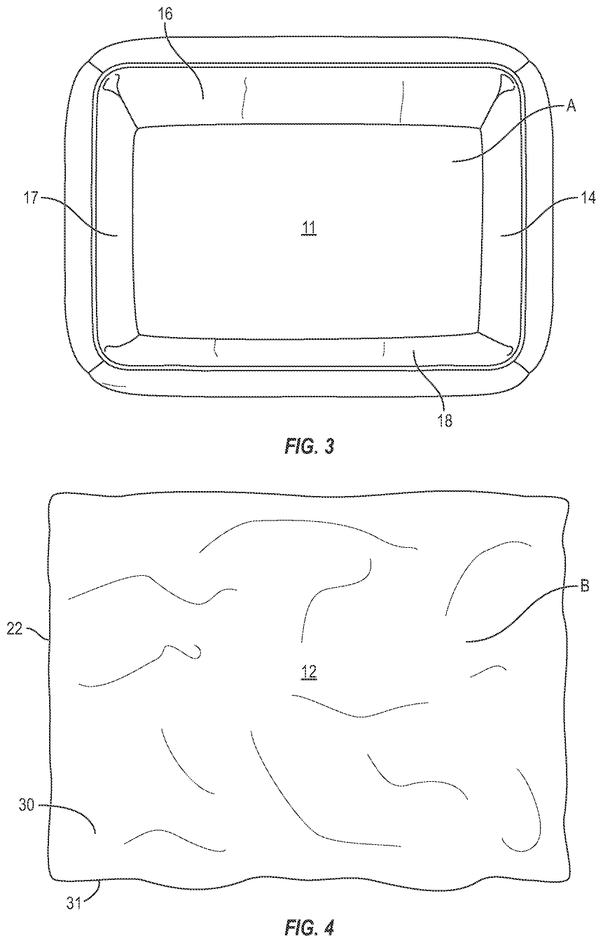

In turning to FIG. 1, pet bed 10 is depicted. Pet bed 10 includes cushion 11 having a top surface area A (FIG. 3) and cushion peripheral edge 13. In this embodiment, peripheral edge 13 defines cushion 11 as having a substantially rectangular footprint although there is no limit as to the shape of the inventive bed. A rectangular shape is illustrated only as a non-limiting example thereof.

Sidewalls 14, 16, 17 and 18 extend from cushion 11. The sidewalls define exposed top surface area A within which cushion 11 receives and supports a pet during use.

Pet bed 10 also includes blanket 12. Importantly, blanket 12 is of a size (surface area B) greater then surface area A of the expose cushion although the composition of blanket 12 is not particularly critical in producing the present invention so long as the blanket enables cats to knead and dogs to burrow. A plush fabric would be ideal. Blanket 12 is also defined as having periphery 22 whereby, in a first embodiment, the entirety of blanket peripheral edge 22 is affixed proximate region 29 where cushion 11 contacts sidewalls 14, 16, 17 and 18. Alternatively, sidewalls 14, 16, 17 and 18 can be joined to peripheral edge 13 of cushion 11 and blanket 12 can also be affixed at joinder seam 25 between the sidewalls and the peripheral edge of cushion 11.

It is an important feature the present invention that the entirety of peripheral edge 22 of blanket 12 be affixed proximate where the cushion contacts the sidewalls in order to completely cover shell fabric 15 of cushion 11 for providing a plush wrinkled blanket as the bed's top support surface instead of its relatively taut shell 15. The bed provides cushion through the material enclosed with shell fabric 15 and will depend upon blanket 12 for such cushioning. At no point is peripheral edge 22 of blanket 12 unattached to the joinder of the cushion and sidewalls or at the cushion peripheral edge. Thus, an animal using pet bed 10 is prevented from burrowing beneath blanket 12 thus precluding blanket 12 from representing a safety hazard. Stated differently, blanket 12 comprises a single continuous membrane having a top surface 30 and a bottom surface 31 such that when affixed to the supporting structure of pet bed 10, a pet is prevented access beneath top surface 30 of blanket or continuous membrane 12.

In summary, the present invention involves a pet bed such as the type having a cushion bounded by sidewalls but, unlike conventional beds, the present invention incorporates blanket 12 having a surface area considerably larger than the surface area presented by cushion 11, the blanket being bound on the entirety of its peripheral edge 22 proximate where the cushion meets the bed sidewalls. Blanket 12 provides a nurturing surface enabling a pet to nuzzle within the creases, bulges, intents and bunched fabric which provides a much more nurturing surface that is typical of pet beds currently available.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

What is claimed is:

1. A pet bed comprising a cushion having a top surface area and a cushion peripheral edge,
sidewalls extending from said cushion within which said cushion receives and supports a pet during use,
a blanket, said blanket being sized larger than said top surface area having a blanket peripheral edge,
whereby the entirety of said blanket peripheral edge is affixed proximate where said cushion contacts said sidewalls to reside atop said cushion.

2. The pet bed of claim 1 whereby said sidewalls are joined to said cushion at said cushion peripheral edge.

3. The pet bed of claim 1 whereby said blanket is affixed atop said cushion by joining said blanket peripheral edge to said cushion peripheral edge such that when in use, a pet contacts only said blanket and is prevented from contact with said cushion.

4. The pet bed of claim 1 whereby said blanket comprises a single continuous membrane having a top surface and bottom surface such that when affixed thereto, a pet is prevented access beneath said top surface of said continuous membrane.
